(19) United States
(12) Patent Application Publication
(10) Pub. No.: US 2024/0297511 A1
(43) Pub. Date: Sep. 5, 2024

(54) POWER SUPPLY SYSTEM

(71) Applicant: HONDA MOTOR CO., LTD., Tokyo (JP)

(72) Inventors: Daichi WATANABE, Saitama (JP); Yasushi Ogihara, Saitama (JP); Yasuo Yamada, Saitama (JP)

(73) Assignee: HONDA MOTOR CO., LTD., Tokyo (JP)

(21) Appl. No.: 18/582,687

(22) Filed: Feb. 21, 2024

(30) Foreign Application Priority Data
Feb. 27, 2023 (JP) 2023-028787

(51) Int. Cl. H02J 7/00; H01M 10/42; H01M 10/613; H01M 10/625; H01M 50/233; H01M 50/264

(52) U.S. Cl. CPC H02J 7/00309; H01M 10/425; H01M 10/613; H01M 50/233; H01M 50/264; H02J 7/0048; H02J 7/007194; H01M 2010/4271; H01M 10/625

(57) ABSTRACT

A power supply system includes a battery pack including a solid-state battery cell and a restraining member, and a battery control device which controls power on charge and discharge of the battery pack. During a charge of the battery pack, the restraining member is compressed due to expansion of the solid-state battery cell, and a surface pressure applied to the solid-state battery cell is increased. During a discharge of the battery pack, the restraining member is restored due to contraction of the solid-state battery cell, and the surface pressure is decreased. The battery control device performs control to limit an output opening rate of the battery pack in a case where a temperature of the battery pack is equal to or higher than a control start temperature, and sets the control start temperature based on a usage state of the battery pack and a battery state of the battery pack.

### CROSS-REFERENCE TO RELATED APPLICATIONS

This application is based on and claims priority under 35 USC 119 from Japanese Patent Application No. 2023-028787 filed on Feb. 27, 2023, the entire content of which is incorporated herein by reference.

### TECHNICAL FIELD

The present disclosure relates to a power supply system including a battery pack and a battery control device.

### BACKGROUND ART

In recent years, researches and developments have been conducted on a secondary battery which contributes to improvement in energy efficiency in order to allow more people to have access to affordable, reliable, sustainable and advanced energy. In the secondary battery, researches on a solid-state battery in which a solid material is used in at least a part of electrolytes have been actively conducted in recent years.

In a power supply system including a battery pack and a battery control device, it is necessary to maintain a temperature of the battery pack at a temperature lower than an upper limit working temperature from the viewpoint of ensuring safety. For example, JP2011-100622A discloses a solid-state battery system that cools a solid-state battery when a temperature of the solid-state battery is equal to or higher than a predetermined temperature.

However, in a power supply system including a battery pack and a battery control device, while it is necessary to maintain a temperature of the battery pack at a temperature lower than an upper limit working temperature, it is required to more efficiently utilize battery performance of the battery pack.

### SUMMARY OF INVENTION

The present disclosure provides a power supply system capable of more efficiently utilizing battery performance of a battery pack while maintaining a temperature of the battery pack at a temperature lower than an upper limit working temperature. This further contributes to improvement in energy efficiency.

An aspect of the present disclosure relates to a power supply system including: a battery pack including a solid-state battery cell and a restraining member configured to restrain the solid-state battery cell; and
a battery control device configured to control power on charge and discharge of the battery pack,
in which during a charge of the battery pack, the restraining member is compressed due to expansion of the solid-state battery cell, and a surface pressure applied to the solid-state battery cell is increased,
during a discharge of the battery pack, the restraining member is restored due to contraction of the solid-state battery cell, and the surface pressure applied to the solid-state battery cell is decreased, and
the battery control device is configured to:
   enable to perform temperature-rise-suppression output limitation control in which an output opening rate of the battery pack is limited in a case where a temperature of the battery pack is equal to or higher than a control start temperature; and
   set the control start temperature based on a usage state of the battery pack and a battery state of the battery pack in the temperature-rise-suppression output limitation control.

According to the present disclosure, battery performance of a battery pack can be utilized more efficiently while maintaining a temperature of the battery pack at a temperature lower than an upper limit working temperature.

### BRIEF DESCRIPTION OF DRAWINGS

Exemplary embodiment(s) of the present invention will be described in detail based on the following figures, wherein:

FIG. 1 is a block diagram of a vehicle including a power supply system according to an embodiment of the present disclosure;

FIG. 2 is a schematic diagram of a battery pack in the power supply system according to the embodiment of the present disclosure;

FIG. 3 is a graph showing a relationship between a remaining charged amount of a solid-state battery cell and a surface pressure applied to the solid-state battery cell during a discharge and a charge of the battery pack of FIG. 2;

FIG. 4A is a graph showing a relationship between a remaining charged amount of the solid-state battery cell according to a usage state and a discharge DCIR of the solid-state battery cell and a correlation of a heat generation amount in the battery pack of FIG. 2;

FIG. 4B is a graph showing a relationship between a remaining charged amount of the solid-state battery cell according to a usage state and a discharge DCIR of the solid-state battery cell and a correlation of a heat generation amount in the battery pack of FIG. 2;

FIG. 5 is a table showing, in the battery pack of FIG. 2, respective states in a case where a usage state of the battery pack is classified into a discharge state and a charge state and a battery state of the battery pack is classified into a high remaining-charged-amount state (high SOC state) and a low remaining-charged-amount state (low SOC state), and a heat generation amount and a control start temperature in temperature-rise-suppression output limitation control in each state;

FIG. 6 is a graph showing a relationship between a battery temperature and an output opening rate, and a control start temperature in the temperature-rise-suppression output limitation control in each state of FIG. 5 in the power supply system according to the embodiment of the present disclosure;

FIG. 7A shows time-series transitions of a temperature of the battery pack and an input and output current in state 2;

FIG. 7B shows time-series transitions of a temperature of the battery pack and an input and output current in state 3, in a case where the control start temperature in the temperature-rise-suppression output limitation control in each state of FIG. 5 is set as shown in FIG. 6; and

FIG. 8 is a flowchart illustrating a setting flow of a control start temperature used for the temperature-rise-suppression output limitation control in the power supply system according to the embodiment of the present disclosure.

### DESCRIPTION OF EMBODIMENTS

Hereinafter, an embodiment of a power supply system of the present disclosure will be described with reference to the accompanying drawings. The drawings are viewed from directions of reference numerals.

### <Power Supply System>

A power supply system 10 of the present embodiment is mounted on a vehicle.

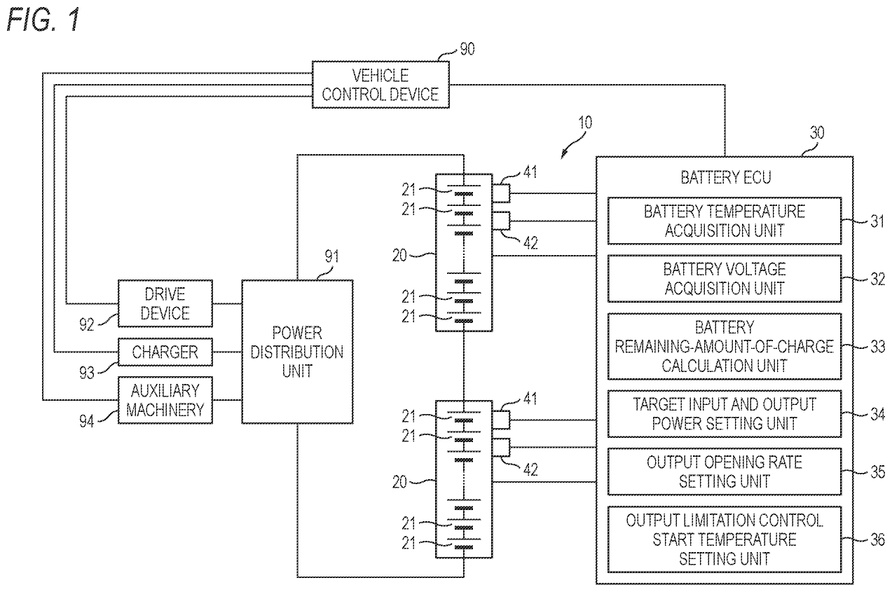

As shown in FIG. 1, the power supply system 10 includes a battery pack 20 and a battery ECU 30.

In the present embodiment, the power supply system 10 includes two battery packs 20, and the two battery packs 20 are connected in series.

The battery pack 20 is connected to a power distribution unit 91. The power distribution unit 91 is connected to a drive device 92, a charger 93, auxiliary machinery 94, and the like mounted on the vehicle. The drive device 92 includes, for example, an electric motor for driving the vehicle. The vehicle can travel with power of the electric motor. The charger 93 includes a power conversion device that receives AC power from a power supply device outside the vehicle and converts the AC power into DC power of a predetermined voltage. The battery pack 20 can be charged with power from the power supply device outside the vehicle converted by the charger 93. The auxiliary machinery 94 includes a vehicle air conditioner and the like. The power of the battery pack 20 can be supplied to the auxiliary machinery 94, and the auxiliary machinery 94 can be operated by the power supplied from the battery pack 20.

The battery pack 20 is installed with a battery voltage sensor 41 that detects input and output voltages of the battery pack 20 and a battery temperature sensor 42 that detects a temperature of the battery pack 20.

The battery ECU 30 is connected to the battery pack 20. The battery ECU 30 controls power on charge and discharge of the battery pack 20.

The battery voltage sensor 41 and the battery temperature sensor 42 are connected to the battery ECU 30. The battery voltage sensor 41 and the battery temperature sensor 42 output detection signals to the battery ECU 30.

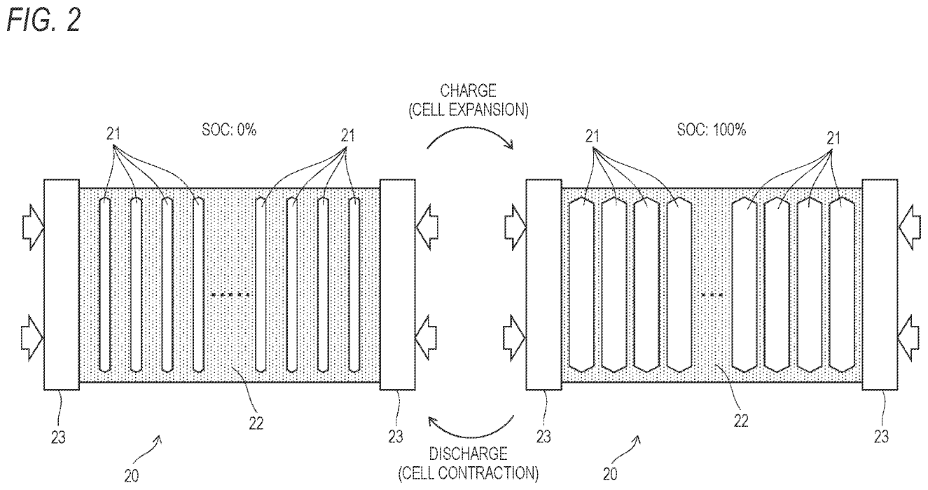

As shown in FIG. 2, the battery pack 20 includes a plurality of solid-state battery cells 21, a cushion member 22 that restrains the plurality of solid-state battery cells 21, and an end plate 23.

Each of the solid-state battery cells 21 is a secondary battery in which a solid material is used as at least a part of an electrolyte. The solid-state battery cell 21 is not limited to an all-solid-state battery using only a solid electrolyte in an electrolyte, and may be a semi-solid-state battery. The solid-state battery cell 21 may be, for example, a gel-polymer-type semi-solid-state battery in which an electrolytic solution is contained in a polymer gel, a clay-type semi-solid-state battery using a clay-like material in which an electrolytic solution is kneaded into a positive/negative electrode material, or a liquid-addition-type semi-solid-state battery in which a small amount of a liquid material having fluidity or a gel polymer having flexibility is added to a solid electrolyte.

The solid-state battery cell 21 is square or laminated. In the battery pack 20, the plurality of solid-state battery cells 21 are stacked in a first direction. The solid-state battery cell 21 has a predetermined thickness in the first direction, and a surface perpendicular to the first direction is substantially planar.

The cushion member 22 is a restraining member that restrains the plurality of solid-state battery cells 21. A space between the solid-state battery cells 21 adjacent to each other in the first direction is filled with the cushion member 22.

A pair of end plates 23 is provided on one side and the other side in the first direction of an assembly of the stacked plurality of solid-state battery cells 21. Therefore, the assembly of the stacked plurality of solid-state battery cells 21 is disposed between the pair of end plates 23 in the first direction. A space between the solid-state battery cell 21 disposed on the most one side in the first direction and the end plate 23 and a space between the solid-state battery cell 21 disposed on the most other side in the first direction and the end plate 23 are both filled with the cushion member 22.

As shown in FIG. 2, each of the solid-state battery cell 21 contracts during a discharge of the battery pack 20, whereas each of the solid-state battery cells 21 expands during a charge of the battery pack 20. Therefore, during the charge of the battery pack 20, the cushion member 22 is compressed due to expansion of the solid-state battery cell 21, and a surface pressure applied to the solid-state battery cell 21 increases. On the other hand, during the discharge of the battery pack 20, the cushion member 22 is restored due to contraction of the solid-state battery cell 21, and the surface pressure applied to the solid-state battery cell 21 decreases.

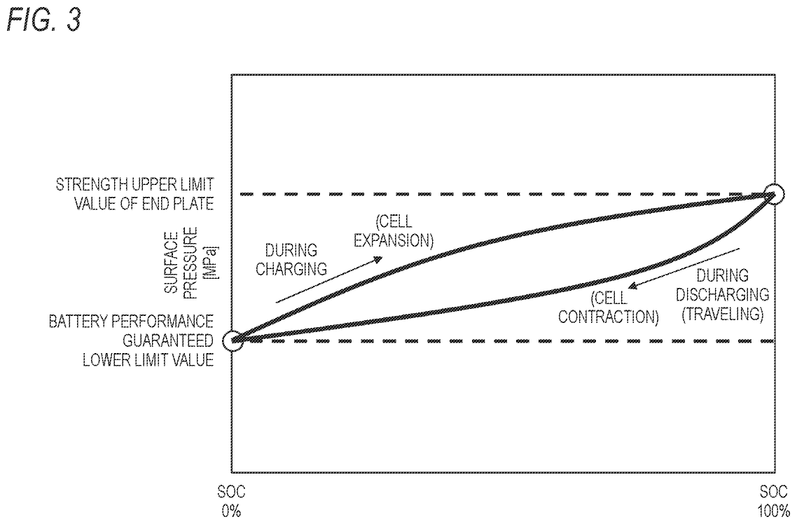

At this time, a relationship between a remaining charged amount of the solid-state battery cell 21 and the surface pressure applied to the solid-state battery cell 21 in a case where the remaining charged amount of the solid-state battery cell 21 is represented by a horizontal axis and the surface pressure applied to the solid-state battery cell 21 is represented by a vertical axis is as shown in FIG. 3.

As shown in FIG. 3, when the remaining charged amount (SOC: state of charge) of the battery pack 20 is 0%, the surface pressure applied to the solid-state battery cell 21 is equal to or larger than a battery performance guaranteed lower limit value. In a state where the surface pressure applied to the solid-state battery cell 21 is equal to or smaller than a predetermined value, the contact resistance between a solid electrolyte interface and an electrode active material becomes high, and the necessary battery performance cannot be ensured. Therefore, the battery performance guaranteed lower limit value is set as a lower limit voltage at which the battery performance can be ensured. On the other hand, when the remaining charged amount of the battery pack 20 is 100%, the surface pressure applied to the solid-state battery cell 21 is equal to or smaller than a strength upper limit value of the end plate 23.

During the charge of the battery pack 20, as the remaining charged amount of the solid-state battery cell 21 increases, the surface pressure applied to the solid-state battery cell 21 increases in an upward convex curve. In contrast, during the discharge of the battery pack 20, as the remaining charged amount of the solid-state battery cell 21 decreases, the surface pressure applied to the solid-state battery cell 21 decreases in a downward convex curve.

Thus, the relationship between the remaining charged amount of the solid-state battery cell 21 and the surface pressure applied to the solid-state battery cell 21 exhibits hysteresis characteristics during the charge and the discharge.

Furthermore, since the surface pressure applied to the solid-state battery cell 21 according to the remaining charged amount of the solid-state battery cell 21 exhibits hysteresis characteristics during the charge and the discharge, a direct current internal resistance (hereinafter also referred to as DCIR) of the solid-state battery cell 21 also exhibits hysteresis characteristics.

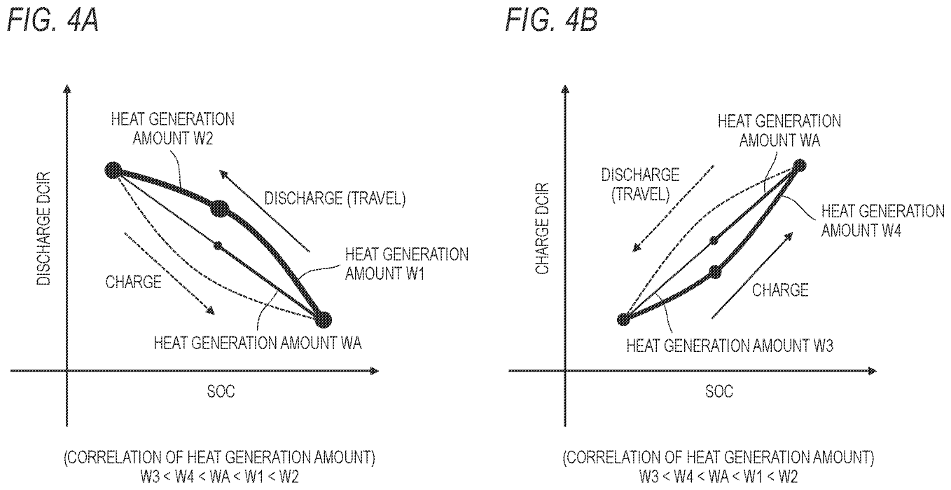

FIGS. 4A and 4B show relationships between the remaining charged amount of the solid-state battery cell 21 and a discharge DCIR or a charge DCIR of the solid-state battery cell 21 in a case where the remaining charged amount of the solid-state battery cell 21 is represented by the horizontal axis and the discharge DCIR or the charge DCIR of the solid-state battery cell 21 is represented by the vertical axis. FIG. 4A and FIG. 4B are diagrams in which the remaining charged amount and a reference current value of the solid-state battery cell 21 are adjusted so that heat generation amounts are the same, considering that the discharge DCIR and the charge DCIR are different.

As shown in FIG. 4A, as the remaining charged amount of the solid-state battery cell 21 decreases due to discharging, the discharge DCIR increases in an upward convex curve as indicated by a thick line. For reference, when the remaining charged amount of the solid-state battery cell 21 increases due to charging, the discharge DCIR decreases in a downward convex curve as indicated by a dotted line. The thin line indicates a discharge DCIR in a case where it is assumed that the surface pressure applied to the solid-state battery cell 21 has no hysteresis characteristics. The details thereof depend on a battery configuration, and the discharge DCIR generally indicates a negative correlation with the remaining charged amount.

As shown in FIG. 4B, as the remaining charged amount of the solid-state battery cell 21 increases due to charging, the discharge DCIR increases in a downward convex curve as indicated by a thick line. For reference, when the remaining charged amount of the solid-state battery cell 21 decreases due to discharging, the charge DCIR decreases in an upward convex curve as indicated by a dotted line. The thin line indicates a charge DCIR in the case where it is assumed that the surface pressure applied to the solid-state battery cell 21 has no hysteresis characteristics. The details thereof depend on a battery configuration, and the charge DCIR generally indicates a positive correlation with the remaining charged amount.

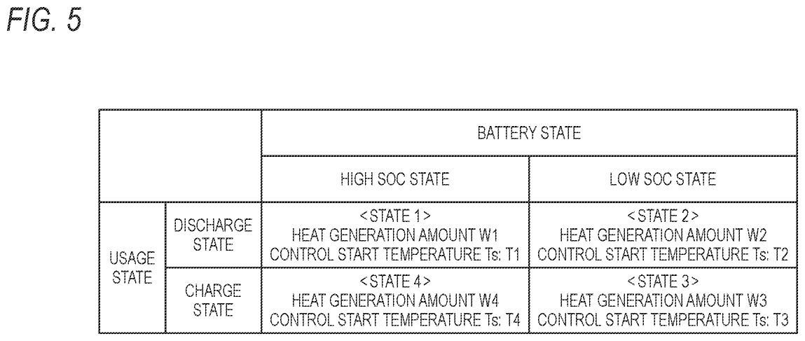

As shown in FIG. 5, a usage state of the battery pack 20 is classified into a discharge state and a charge state, and a battery state of the battery pack 20 is classified into a high remaining-charged-amount state (high SOC state) and a low remaining-charged-amount state (low SOC state). A state in which the usage state of the battery pack 20 is the discharge state and the battery state of the battery pack 20 is the high SOC state is referred to as state 1, a state in which the usage state of the battery pack 20 is the discharge state and the battery state of the battery pack 20 is the low SOC state is referred to as state 2, a state in which the usage state of the battery pack 20 is the charge state and the battery state of the battery pack 20 is the low SOC state is referred to as state 3, and a state in which the usage state of the battery pack 20 is the charge state and the battery state of the battery pack 20 is the high SOC state is referred to as state 4.

Assuming that a heat generation amount of the solid-state battery cell 21 in state 1 is denoted by W1, a heat generation amount of the solid-state battery cell 21 in state 2 is denoted by W2, a heat generation amount of the solid-state battery cell 21 in state 3 is denoted by W3, and a heat generation amount of the solid-state battery cell 21 in state 4 is denoted by W4, and a heat generation amount of the solid-state battery cell 21 in the case where it is assumed that the surface pressure applied to the solid-state battery cell 21 has no hysteresis characteristics is denoted by WA, the heat generation amount of the solid-state battery cell 21 is substantially proportional to an internal resistance value of the solid-state battery cell 21. Therefore, as shown in FIG. 4A, WA<W1<W2 is satisfied, and as shown in FIG. 4B, W3<W4<WA is satisfied. Therefore, the relationship between the heat generation amounts W1 to W4 of the solid-state battery cell 21 in state 1 to state 4 and the heat generation amount WA of the solid-state battery cell 21 in the case where it is assumed that the surface pressure applied to the solid-state battery cell 21 has no hysteresis characteristics satisfies W3<W4<WA<W1<W2.

Therefore, regarding the cases of state 1 to state 4, the temperature of the battery pack 20 tends to increase in order of (state 2)> (state 1)> (assuming that the surface pressure applied to the solid-state battery cell 21 has no hysteresis characteristics)> (state 4)> (state 3).

Returning to FIG. 1, the battery ECU 30 is connected to the battery pack 20. The battery ECU 30 controls power on charge and discharge of the battery pack 20.

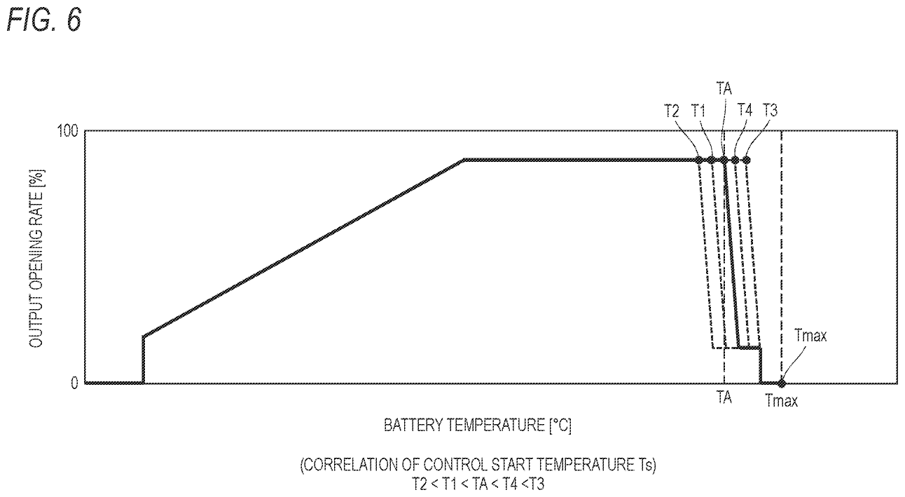

In a case where the temperature of the battery pack 20 is equal to or higher than a control start temperature Ts, the battery ECU 30 enables to perform temperature-rise-suppression output limitation control for limiting an output opening rate of the battery pack 20. FIG. 6 shows an example of the temperature-rise-suppression output limitation control.

The battery ECU 30 includes a battery temperature acquisition unit 31, a battery voltage acquisition unit 32, a battery remaining-charged-amount calculation unit 33, a target input and output power setting unit 34, an output opening rate setting unit 35, and an output limitation control start temperature setting unit 36.

In the present embodiment, the battery ECU 30 is connected to a vehicle control device 90 mounted on the vehicle. The vehicle control device 90 includes a large number of electronic control units (ECUs), and performs driving control of the vehicle, integrated control of the auxiliary machinery, and the like. The vehicle control device 90 outputs a signal related to control on the battery pack 20 to the battery ECU 30.

The battery ECU 30 sets target input and output power of the battery pack 20 in the target input and output power setting unit 34 based on the signal related to the control on the battery pack 20 output from the vehicle control device 90. The battery ECU 30 outputs a signal indicating the target input and output power set by the target input and output power setting unit 34 to the battery pack 20, and performs control such that the input and output power of the battery pack 20 becomes the target input and output power set by the target input and output power setting unit 34.

The battery temperature acquisition unit 31 acquires the temperature of the battery pack 20 based on a detection signal output from the battery voltage sensor 41.

The battery voltage acquisition unit 32 acquires input and output voltages of the battery pack 20 based on a detection signal output from the battery temperature sensor 42.

The battery remaining-charged-amount calculation unit 33 calculates a remaining charged amount of the battery pack 20 based on the temperature of the battery pack 20 acquired by the battery temperature acquisition unit 31 and the input and output voltages of the battery pack 20 acquired by the battery voltage acquisition unit 32.

The output opening rate setting unit 35 sets an output opening rate of the battery pack 20 based on the temperature of the battery pack 20 acquired by the battery temperature acquisition unit 31. In the present embodiment, the battery ECU 30 stores in advance a table indicating the output opening rate corresponding to the temperature of the battery pack 20 as shown in FIG. 6. The output opening rate setting unit 35 sets the output opening rate of the battery pack 20 based on the temperature of the battery pack 20 acquired by the battery temperature acquisition unit 31.

In a case where the temperature of the battery pack 20 acquired by the battery temperature acquisition unit 31 is equal to or higher than the control start temperature Ts, the output opening rate setting unit 35 limits the output opening rate of the battery pack 20 according to the table indicating the output opening rate corresponding to the temperature of the battery pack 20 shown in FIG. 6. In this way, in a case where the temperature of the battery pack 20 acquired by the battery temperature acquisition unit 31 is equal to or higher than the control start temperature Ts, the battery ECU 30 enables to perform the temperature-rise-suppression output limitation control for limiting the output opening rate of the battery pack 20.

The temperature-rise-suppression output limitation control is performed, and in a case where the temperature of the battery pack 20 is equal to or higher than the control start temperature Ts, the output opening rate of the battery pack 20 is limited. Therefore, the battery pack 20 can be prevented from reaching an upper limit working temperature Tmax. Accordingly, the temperature of the battery pack 20 can be maintained at a temperature lower than the upper limit working temperature Tmax.

The output limitation control start temperature setting unit 36 sets the control start temperature Ts in the temperature-rise-suppression output limitation control. The output limitation control start temperature setting unit 36 sets the control start temperature Ts based on the usage state of the battery pack 20 and the battery state of the battery pack 20.

Therefore, based on the usage state of the battery pack 20 and the battery state of the battery pack 20, the output limitation control start temperature setting unit 36 can set the control start temperature Ts to a high temperature in a case where the surface pressure applied to the battery pack 20 is large and the heat generation amount of the battery pack 20 is small, and can set the control start temperature Ts to a low temperature in a case where the surface pressure applied to the battery pack 20 is small and the heat generation amount of the battery pack 20 is large.

Accordingly, an optimum control start temperature Ts can be set based on the usage state of the battery pack 20 and the battery state of the battery pack 20, and thus the battery performance of the battery pack 20 can be utilized more efficiently while maintaining the temperature of the battery pack 20 at a temperature lower than the upper limit working temperature Tmax.

In the output limitation control start temperature setting unit 36, the usage state of the battery pack 20 used for setting the control start temperature Ts includes charge and discharge states of the battery pack 20, and the battery state of the battery pack 20 includes the remaining charged amount of the battery pack 20.

Accordingly, the control start temperature Ts can be set according to the heat generation amount of the battery pack 20, which varies depending on the surface pressure applied to the battery pack 20, based on the charge and discharge states of the battery pack 20 and the remaining charged amount of the battery pack 20. Therefore, an optimum control start temperature Ts can be set according to the heat generation amount of the battery pack 20.

When the control start temperature Ts is set in the output limitation control start temperature setting unit 36, the usage state of the battery pack 20 is classified into a discharge state and a charge state based on the charge and discharge states of the battery pack 20, and the battery state of the battery pack 20 is classified into a high SOC state and a low SOC state based on the remaining charged amount of the battery pack 20. The control start temperature Ts is set based on whether the usage state of the battery pack 20 is the discharge state or the charge state and whether the battery state of the battery pack 20 is the high SOC state or the low SOC state.

Accordingly, an optimum control start temperature Ts corresponding to the heat generation amount of the battery pack 20, which varies depending on the surface pressure applied to the battery pack 20, can be set by simple control.

In the temperature-rise-suppression output limitation control, the output limitation control start temperature setting unit 36 sets a control start temperature Ts for a case where the usage state of the battery pack 20 is the charge state to be higher than a control start temperature Ts for a case where the usage state of the battery pack 20 is the discharge state.

As described above, during the charge of the battery pack 20, as the remaining charged amount of the solid-state battery cell 21 increases, the surface pressure applied to the solid-state battery cell 21 increases in an upward convex curve. In contrast, during the discharge of the battery pack 20, as the remaining charged amount of the solid-state battery cell 21 decreases, the surface pressure applied to the solid-state battery cell 21 decreases in a downward convex curve (see FIG. 3). Therefore, in a case where the remaining amounts of charge of the solid-state battery cells 21 are the same, the surface pressure applied to the battery pack 20 during the charge of the battery pack 20 is higher than that during the discharge of the battery pack 20. Therefore, the internal resistance value and the heat generation amount of the battery pack 20 during the charge of the battery pack 20 are smaller than those during the discharge of the battery pack 20. Therefore, even if the control start temperature Ts for the case where the usage state of the battery pack 20 is the charge state is set to be higher than the control start temperature Ts for the case where the usage state of the battery pack 20 is the discharge state, the temperature of the battery pack 20 can be maintained at a temperature lower than the upper limit working temperature Tmax.

Accordingly, in the temperature-rise-suppression output limitation control, by setting the control start temperature Ts for the case where the usage state of the battery pack 20 is the charge state to be higher than the control start temperature Ts for the case where the usage state of the battery pack 20 is the discharge state, the battery performance of the battery pack 20 can be utilized more efficiently while maintaining the temperature of the battery pack 20 at a temperature lower than the upper limit working temperature Tmax.

More specifically, as described above with reference to FIG. 5, the usage state of the battery pack 20 is classified into the discharge state and the charge state, and the battery state of the battery pack 20 is classified into the high remaining-charged-amount state (high SOC state) and the low remaining-charged-amount state (low SOC state). A state in which the usage state of the battery pack 20 is the discharge state and the battery state of the battery pack 20 is the high SOC state is referred to as state 1, a state in which the usage state of the battery pack 20 is the discharge state and the battery state of the battery pack 20 is the low SOC state is referred to as state 2, a state in which the usage state of the battery pack 20 is the charge state and the battery state of the battery pack 20 is the low SOC state is referred to as state 3, and a state in which the usage state of the battery pack 20 is the charge state and the battery state of the battery pack 20 is the high SOC state is referred to as state 4.

The output limitation control start temperature setting unit 36 determines which of state 1 to state 4 the state of the battery pack 20 belongs to based on the charge and discharge states of the battery pack 20 and the remaining charged amount of the battery pack 20, and sets (updates) the control start temperature Ts to T1 in the case of state 1, to T2 in the case of state 2, to T3 in the case of state 3, and to T4 in the case of state 4.

As described above, the relationship between the heat generation amounts W1 to W4 of the solid-state battery cell 21 in state 1 to state 4 and the heat generation amount WA of the solid-state battery cell 21 in the case where it is assumed that the surface pressure applied to the solid-state battery cell 21 has no hysteresis characteristics satisfies W3<W4<WA<W1<W2. Therefore, regarding the cases of state 1 to state 4, the temperature of the battery pack 20 tends to increase in order of (state 2)> (state 1)> (assuming that the surface pressure applied to the solid-state battery cell 21 has no hysteresis characteristics)> (state 4)>(state 3).

As shown in FIG. 6, when the control start temperature Ts in the case where it is assumed that the surface pressure applied to the solid-state battery cell 21 has no hysteresis characteristics is a reference control start temperature TA, the output limitation control start temperature setting unit 36 sets the control start temperature Ts such that T2<T1<TA<T4<T3 is satisfied.

Therefore, when the usage state of the battery pack 20 is the discharge state, the output limitation control start temperature setting unit 36 sets the control start temperature Ts for a case where the battery state of the battery pack 20 is the high SOC state, that is, T1, to be higher than the control start temperature Ts for a case where the battery state of the battery pack 20 is the low SOC state, that is, T2.

As described above, when the usage state of the battery pack 20 is the discharge state, in a case of the high SOC state in which the heat generation amount of the battery pack 20 is small, the control start temperature Ts is set to a higher temperature than in a case of the low SOC state in which the heat generation amount of the battery pack 20 is large. Therefore, the battery performance of the battery pack 20 can be utilized while maintaining the temperature of the battery pack 20 at a temperature lower than the upper limit working temperature Tmax.

Further, when the usage state of the battery pack 20 is the charge state, the output limitation control start temperature setting unit 36 sets the control start temperature Ts for the case where the battery state of the battery pack 20 is the low SOC state, that is, T3, to be higher than the control start temperature Ts for the case where the battery state of the battery pack 20 is the high SOC state, that is, T4.

As described above, when the usage state of the battery pack 20 is the charge state, in a case of the low SOC state in which the heat generation amount of the battery pack 20 is small, the control start temperature Ts is set to a higher temperature than in a case of the high SOC state in which the heat generation amount of the battery pack 20 is large. Therefore, the battery performance of the battery pack 20 can be utilized more efficiently while maintaining the temperature of the battery pack 20 at a temperature lower than the upper limit working temperature Tmax.

In the output limitation control start temperature setting unit 36, the usage state and the battery state of the battery pack 20 are classified into state 1 to state 4, and the control start temperature Ts is set such that T2<T1<TA<T4<T3 according to state 1 to state 4. Therefore, in consideration of a change in the heat generation amount of the battery pack 20 due to a change in the surface pressure applied to the battery pack 20 according to the usage state and the battery state of the battery pack 20, the battery performance of the battery pack 20 can be utilized more efficiently while maintaining the temperature of the battery pack 20 at a temperature lower than the upper limit working temperature Tmax.

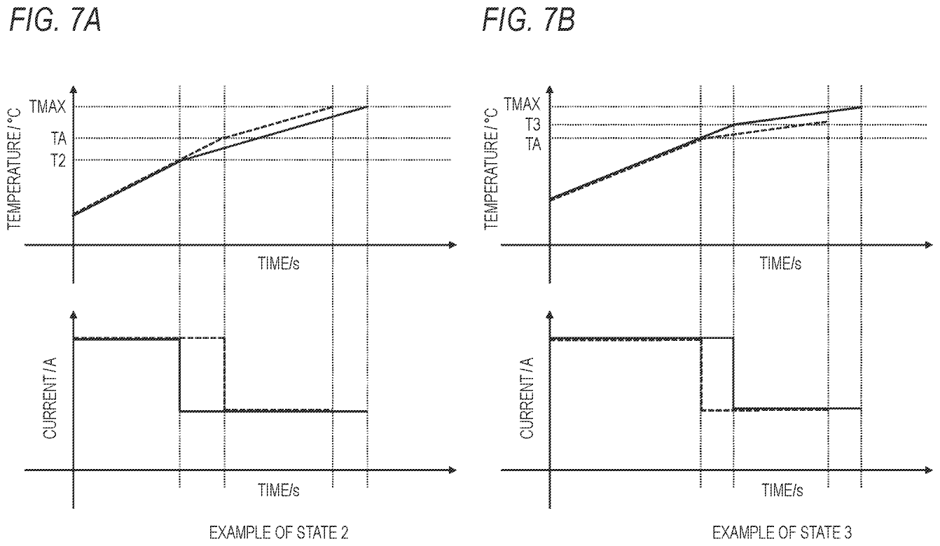

Specifically, for example, as shown in FIG. 7A, in a case where the usage state of the battery pack 20 is the discharge state and the battery state of the battery pack 20 is the low SOC state (the above-described state 2), the heat generation amount W2 is larger than the heat generation amount WA of the solid-state battery cell 21 in the case where it is assumed that the surface pressure applied to the solid-state battery cell 21 has no hysteresis characteristics. Therefore, when the control start temperature Ts is set to the reference control start temperature TA, the battery pack 20 reaches the upper limit working temperature Tmax earlier than expected as indicated by a broken line in FIG. 7A. Therefore, by setting the control start temperature Ts to T2, which is lower than the reference control start temperature TA, the battery pack 20 can be continuously used without reaching the upper limit working temperature Tmax as indicated by a solid line in FIG. 7A.

For example, as shown in FIG. 7B, in a case where the usage state of the battery pack 20 is the charge state and the battery state of the battery pack 20 is the low SOC state (the above-described state 3), the heat generation amount W3 is smaller than the heat generation amount WA of the solid-state battery cell 21 in the case where it is assumed that the surface pressure applied to the solid-state battery cell 21 has no hysteresis characteristics. Therefore, when the control start temperature Ts is set to the reference control start temperature TA, as indicated by a broken line in FIG. 7B, the temperature rises only to a temperature lower than expected, an excessive output limitation is imposed on the upper limit working temperature Tmax, and a charged amount of the battery pack 20 may become insufficient. Therefore, by setting the control start temperature Ts to T3, which is higher than the reference control start temperature TA, the battery pack 20 can be used until the temperature reaches a temperature closer to the upper limit working temperature Tmax as indicated by a solid line in FIG. 7B, and a sufficient charged amount of the battery pack 20 can be secured.

### <Setting Flow of Control Start Temperature Used for Temperature-Rise-Suppression Output Limitation Control>

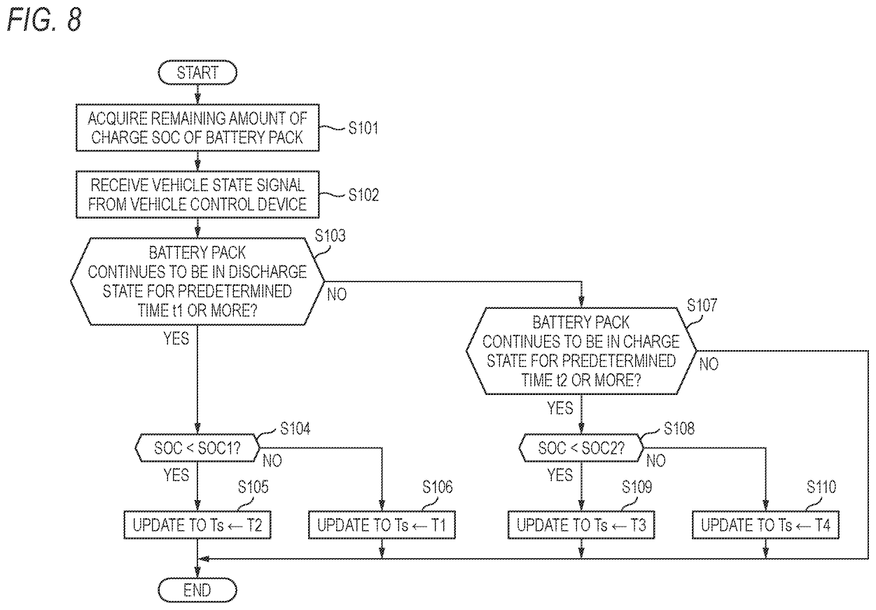

Subsequently, a setting flow of the control start temperature Ts used for the temperature-rise-suppression output limitation control will be described with reference to FIG. 8.

The battery ECU 30 first causes the battery remaining-charged-amount calculation unit 33 to acquire a remaining charged amount SOC [%] of the battery pack 20 by calculation (step S101).

Subsequently, the setting flow proceeds to step S102, in which the battery ECU 30 receives a vehicle state signal from the vehicle control device 90. The vehicle state signal includes information on whether the vehicle is traveling on electric power or is being charged by regeneration or the like. In a case where the vehicle is a hybrid vehicle, the information may further include information on whether the vehicle is traveling with electric assist.

Subsequently, the setting flow proceeds to step S103, in which the battery ECU 30 determines whether the battery pack 20 continues to be in a discharge state for a predetermined time t1 or more. If the battery ECU 30 determines that the battery pack 20 continues to be in the discharge state for the predetermined time t1 or more (step S103: YES), the setting flow proceeds to step S104, and if the battery ECU 30 determines that the battery pack 20 does not continue to be in the discharge state for the predetermined time t1 or more (step S103: NO), the setting flow proceeds to step S107. If the battery pack 20 continues to be in the discharge state for the predetermined time t1 or more (step S103: YES), the battery pack 20 is determined to be in the discharge state. On the other hand, if the battery pack 20 does not continue to be in the discharge state for the predetermined time t1 or more (step S103: NO), the vehicle is in a state of, for example, regenerative charging or electrically assisted traveling for a short time.

In step S104, it is determined whether the remaining charged amount SOC [%] of the battery pack 20 acquired in step S101 is smaller than a predetermined SOC1 [%]. The SOC1 is any value set in advance according to battery characteristics of the battery pack 20.

In step S104, if the remaining charged amount SOC [%] of the battery pack 20 acquired in step S101 is smaller than the predetermined SOC1 [%] (step S104: YES), the setting flow proceeds to step S105, the control start temperature Ts is updated to T2, and a series of setting flows is ended. T2 is the control start temperature Ts set in the case of the above-described state 2, that is, in the case where the usage state of the battery pack 20 is the discharge state and the battery state of the battery pack 20 is the low SOC state.

In step S104, if the remaining charged amount SOC [%] of the battery pack 20 acquired in step S101 is equal to or larger than the predetermined SOC1 [%] (step S104: NO), the setting flow proceeds to step S106, the control start temperature Ts is updated to T1, and the series of setting flows is ended. T1 is the control start temperature Ts set in the case of the above-described state 1, that is, in the case where the usage state of the battery pack 20 is the discharge state and the battery state of the battery pack 20 is the high SOC state.

Further, in step S107, the battery ECU 30 determines whether the battery pack 20 continues to be in a charge state for a predetermined time t2 or more. If the battery ECU 30 determines that the battery pack 20 continues to be in the charge state for the predetermined time t2 or more (step S107: YES), the setting flow proceeds to step S108, and if the battery ECU 30 determines that the battery pack 20 does not continue to be in the charge state for the predetermined time t2 or more (step S107: NO), the series of setting flows is ended without changing or updating the control start temperature Ts. If the battery pack 20 continues to be in the charge state for the predetermined time t2 or more (step S107: YES), the battery pack 20 is determined to be in the charge state. On the other hand, if the battery pack 20 does not continue to be in the charge state for the predetermined time t2 or more (step S107: NO), the vehicle is in a regenerative charge state for a short time, for example.

In step S108, it is determined whether the remaining charged amount SOC [%] of the battery pack 20 acquired in step S101 is smaller than a predetermined SOC2 [%]. The SOC2 is any value set in advance according to battery characteristics of the battery pack 20. The SOC2 may be the same value as the SOC1 described above, or may be a value different from the SOC1.

In step S108, if the remaining charged amount SOC [%] of the battery pack 20 acquired in step S101 is smaller than the predetermined SOC2 [%] (step S108: YES), the setting flow proceeds to step S109, the control start temperature Ts is updated to T3, and the series of setting flows is ended. T3 is the control start temperature Ts set in the case of the above-described state 3, that is, in the case where the usage state of the battery pack 20 is the charge state and the battery state of the battery pack 20 is the low SOC state.

In step S108, if the remaining charged amount SOC [%] of the battery pack 20 acquired in step S101 is equal to or larger than the predetermined SOC2 [%] (step S108: NO), the setting flow proceeds to step S110, the control start temperature Ts is updated to T4, and the series of setting flows is ended. T4 is the control start temperature Ts set in the case of the above-described state 4, that is, in the case where the usage state of the battery pack 20 is the charge state and the battery state of the battery pack 20 is the high SOC state.

As described above, by executing the setting flow of the control start temperature, the usage state of the battery pack 20 is classified into the discharge state and the charge state based on the charge and discharge states of the battery pack 20, and the battery state of the battery pack 20 is classified into the high SOC state and the low SOC state based on the remaining charged amount of the battery pack 20. The control start temperature Ts is set such that T2<T1<T4<T3, where T1 is the control start temperature Ts for a case where the usage state of the battery pack 20 is the discharge state and the battery state of the battery pack 20 is the high SOC state, T2 is the control start temperature Ts for a case where the usage state of the battery pack 20 is the discharge state and the battery state of the battery pack 20 is the low SOC state, T3 is the control start temperature Ts for a case where the usage state of the battery pack 20 is the charge state and the battery state of the battery pack 20 is the low SOC state, and T4 is the control start temperature Ts for a case where the usage state of the battery pack 20 is the charge state and the battery state of the battery pack 20 is the high SOC state.

Accordingly, the control start temperature Ts can be set by simple control so that the battery performance of the battery pack 20 can be utilized more efficiently while maintaining the temperature of the battery pack 20 at a temperature lower than the upper limit working temperature Tmax in consideration of a change in the heat generation amount of the battery pack 20 due to a change in the surface pressure applied to the battery pack 20 according to the usage state and the battery state of the battery pack 20.

Although an embodiment of the present disclosure has been described above with reference to the accompanying drawings, it is needless to say that the present invention is not limited to the embodiment. It is apparent that those skilled in the art can conceive of various modifications and alterations within the scope described in the claims, and it is understood that such modifications and alterations naturally fall within the technical scope of the present invention. In addition, respective constituent elements in the above embodiment may be freely combined without departing from the gist of the invention.

For example, the vehicle on which the power supply system 10 is mounted may be a battery electric vehicle or a hybrid vehicle.

For example, the restraining member that restrains the solid-state battery cell 21 is not limited to the cushion member 22, and may be any member in which the restraining member is compressed due to expansion of the solid-state battery cell 21 during the charge of the battery pack 20 and the surface pressure applied to the solid-state battery cell 21 increases, and the restraining member is restored due to contraction of the solid-state battery cell 21 during the discharge of the battery pack 20 and the surface pressure applied to the solid-state battery cell 21 decreases.

For example, in the present embodiment, the battery ECU 30 receives the vehicle state signal from the vehicle control device 90 in step S102, and determines in step S103 whether the vehicle continues to be in an electric traveling state for the predetermined time t1 or more. However, a current sensor connected to the battery ECU 30 may be attached to the battery pack 20, step S102 may be omitted, and the battery ECU 30 may determine in step S103 whether an output current value I of the battery pack 20 is I>0 for the predetermined time t1 or more. In a case where the output current value I of the battery pack 20 is I>0 for the predetermined time t1 or more, the battery pack 20 is in the discharge state. In this case, in step S107, it may be determined whether the output current value I of the battery pack 20 is I<0 for the predetermined time t2 or more. In a case where the output current value I of the battery pack 20 is I<0 for the predetermined time t2 or more, the battery pack 20 is in the charge state.

In the present description, at least the following matters are described. The parentheses show the corresponding constituent elements and the like in the above embodiment as an example, but the present invention is not limited thereto.

(1) A power supply system (power supply system 10) including:
a battery pack (battery pack 20) including a solid-state battery cell (solid-state battery cell 21) and a restraining member (cushion member 22) configured to restrain the solid-state battery cell; and
a battery control device (battery ECU 30) configured to control power on charge and discharge of the battery pack,
in which during a charge of the battery pack, the restraining member is compressed due to expansion of the solid-state battery cell, and a surface pressure applied to the solid-state battery cell is increased,
during a discharge of the battery pack, the restraining member is restored due to contraction of the solid-state battery cell, and the surface pressure applied to the solid-state battery cell is decreased, and
the battery control device is configured to:
   enable to perform temperature-rise-suppression output limitation control in which an output opening rate of the battery pack is limited in a case where a temperature of the battery pack is equal to or higher than a control start temperature (control start temperature Ts); and
   set the control start temperature based on a usage state of the battery pack and a battery state of the battery pack in the temperature-rise-suppression output limitation control.

According to (1), an optimum control start temperature can be set based on the usage state of the battery pack and the battery state of the battery pack, and thus the battery performance of the battery pack can be utilized more efficiently while maintaining the temperature of the battery pack at a temperature lower than the upper limit working temperature.

(2) The power supply system according to (1),
in which the usage state of the battery pack includes charge and discharge states of the battery pack, and
the battery state of the battery pack includes a remaining charged amount of the battery pack.

According to (2), the control start temperature can be set according to the heat generation amount of the battery pack, which varies depending on the surface pressure applied to the battery pack, based on the charge and discharge states of the battery pack and the remaining charged amount of the battery pack. Therefore, an optimum control start temperature can be set according to the heat generation amount of the battery pack.

(3) The power supply system according to (2),
in which the battery control device is configured to:
   classify the usage state of the battery pack into a discharge state and a charge state, based on the charge and discharge states of the battery pack;
   classify the battery state of the battery pack into a high remaining-charged-amount state and a low remaining-charged-amount state, based on the remaining charged amount of the battery pack; and
   set the control start temperature in the temperature-rise-suppression output limitation control, based on whether the usage state of the battery pack is the discharge state or the charge state and whether the battery state of the battery pack is the high remaining-charged-amount state or the low remaining-charged-amount state.

According to (3), an optimum control start temperature corresponding to the heat generation amount of the battery pack, which varies depending on the surface pressure applied to the battery pack, can be set by simple control.

(4) The power supply system according to (3),
in which the battery control device sets the control start temperature for a case where the usage state of the battery pack is the charge state to be higher than the control start temperature for a case where the usage state of the battery pack is the discharge state, in the temperature-rise-suppression output limitation control.

According to (4), in the temperature-rise-suppression output limitation control, since the control start temperature for the case where the usage state of the battery pack is the charge state is set to be higher than the control start temperature for the case where the usage state of the battery pack is the discharge state, the battery performance of the battery pack can be utilized more efficiently while maintaining the temperature of the battery pack at a temperature lower than the upper limit working temperature.

(5) The power supply system according to (4),
in which in the temperature-rise-suppression output limitation control, when the usage state of the battery pack is the discharge state,
the battery control device sets the control start temperature for a case where the battery state of the battery pack is the high remaining-charged-amount state to be higher than the control start temperature for a case where the battery state of the battery pack is the low remaining-charged-amount state.

According to (5), when the usage state of the battery pack is the discharge state, in the case of the high remaining-charged-amount state in which the heat generation amount of the battery pack is small, the control start temperature is set to a higher temperature than in the case of the low remaining-charged-amount state in which the heat generation amount of the battery pack is large. Therefore, the battery performance of the battery pack can be utilized while maintaining the temperature of the battery pack at a temperature lower than the upper limit working temperature.

(6) The power supply system according to (4) or (5),
in which in the temperature-rise-suppression output limitation control, when the usage state of the battery pack is the charge state,
the battery control device sets the control start temperature for a case where the battery state of the battery pack is the low remaining-charged-amount state to be higher than the control start temperature set for a case where the battery state of the battery pack is the high remaining-charged-amount state.

According to (6), when the usage state of the battery pack is the charge state, in the case of the low remaining-charged-amount state in which the heat generation amount of the battery pack is small, the control start temperature is set to a higher temperature than in the case of the high remaining-charged-amount state in which the heat generation amount of the battery pack is large. Therefore, the battery performance of the battery pack can be utilized more efficiently while maintaining the temperature of the battery pack at a temperature lower than the upper limit working temperature.

(7) The power supply system according to (3),
in which in the temperature-rise-suppression output limitation control,
the control start temperature is set such that T2<T1<T4<T3, where
T1 is the control start temperature for a case where the usage state of the battery pack is the discharge state and the battery state of the battery pack is the high remaining-charged-amount state,
T2 is the control start temperature for a case where the usage state of the battery pack is the discharge state and the battery state of the battery pack is the low remaining-charged-amount state,
T3 is the control start temperature for a case where the usage state of the battery pack is the charge state and the battery state of the battery pack is the low remaining-charged-amount state, and
T4 is the control start temperature for a case where the usage state of the battery pack is the charge state and the battery state of the battery pack is the high remaining-charged-amount state.

According to (7), the battery performance of the battery pack can be utilized more efficiently while maintaining the temperature of the battery pack at a temperature lower than the upper limit working temperature in consideration of a change in the heat generation amount of the battery pack due to a change in the surface pressure applied to the battery pack according to the usage state and the battery state of the battery pack.

What is claimed is:

1. A power supply system comprising:
a battery pack including a solid-state battery cell and a restraining member configured to restrain the solid-state battery cell; and
a battery control device configured to control power on charge and discharge of the battery pack,
wherein during a charge of the battery pack, the restraining member is compressed due to expansion of the solid-state battery cell, and a surface pressure applied to the solid-state battery cell is increased,
during a discharge of the battery pack, the restraining member is restored due to contraction of the solid-state battery cell, and the surface pressure applied to the solid-state battery cell is decreased, and
the battery control device is configured to:
enable to perform temperature-rise-suppression output limitation control in which an output opening rate of the battery pack is limited in a case where a temperature of the battery pack is equal to or higher than a control start temperature; and
set the control start temperature based on a usage state of the battery pack and a battery state of the battery pack in the temperature-rise-suppression output limitation control.

2. The power supply system according to claim 1,
wherein the usage state of the battery pack includes charge and discharge states of the battery pack, and
the battery state of the battery pack includes a remaining charged amount of the battery pack.

3. The power supply system according to claim 2,
wherein the battery control device is configured to:
classify the usage state of the battery pack into a discharge state and a charge state, based on the charge and discharge states of the battery pack;
classify the battery state of the battery pack into a high remaining-charged-amount state and a low remaining-charged-amount state, based on the remaining charged amount of the battery pack; and
set the control start temperature in the temperature-rise-suppression output limitation control, based on whether the usage state of the battery pack is the discharge state or the charge state and whether the battery state of the battery pack is the high remaining-charged-amount state or the low remaining-charged-amount state.

4. The power supply system according to claim 3,
wherein the battery control device sets the control start temperature for a case where the usage state of the battery pack is the charge state to be higher than the control start temperature for a case where the usage state of the battery pack is the discharge state, in the temperature-rise-suppression output limitation control.

5. The power supply system according to claim 4,
wherein in the temperature-rise-suppression output limitation control, when the usage state of the battery pack is the discharge state,
the battery control device sets the control start temperature for a case where the battery state of the battery pack is the high remaining-charged-amount state to be higher than the control start temperature for a case where the battery state of the battery pack is the low remaining-charged-amount state.

6. The power supply system according to claim 4,
wherein in the temperature-rise-suppression output limitation control, when the usage state of the battery pack is the charge state,
the battery control device sets the control start temperature for a case where the battery state of the battery pack is the low remaining-charged-amount state to be higher than the control start temperature set for a case where the battery state of the battery pack is the high remaining-charged-amount state.

7. The power supply system according to claim 3,
wherein in the temperature-rise-suppression output limitation control,
the control start temperature is set such that T2<T1<T4<T3, where
T1 is the control start temperature for a case where the usage state of the battery pack is the discharge state and the battery state of the battery pack is the high remaining-charged-amount state,
T2 is the control start temperature for a case where the usage state of the battery pack is the discharge state and the battery state of the battery pack is the low remaining-charged-amount state,
T3 is the control start temperature for a case where the usage state of the battery pack is the charge state and the battery state of the battery pack is the low remaining-charged-amount state, and
T4 is the control start temperature for a case where the usage state of the battery pack is the charge state and the battery state of the battery pack is the high remaining-charged-amount state.
